(19) United States
(12) Patent Application Publication
(10) Pub. No.: US 2006/0060501 A1
(43) Pub. Date: Mar. 23, 2006

(54) Process for hydroconversion of a heavy feedstock with dispersed catalyst

(76) Inventors: Thierry Gauthier, Brignais (FR); Cyril Collado, Lyon (FR); Alain Ranc, Charly (FR); Stephane Kressmann, Serezin Du Rhone (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/229,706

(22) Filed: Sep. 20, 2005

(30) Foreign Application Priority Data
Sep. 20, 2004 (FR) 04/09.936

(51) Int. Cl. C10G 47/00; C10G 45/04; C10G 47/02; B01J 8/04

(52) U.S. Cl. 208/108; 208/213; 422/190; 422/189

(57) ABSTRACT

The invention relates to a process for hydroconversion in a reaction zone (preferably in a bubbling bed and/or in slurry) of liquid heavy hydrocarbon feedstocks containing sulphur, in the presence of hydrogen and a catalytic solid phase, said solid phase being obtained from a catalytic precursor, a process in which the catalytic precursor is injected into a part of the liquid conversion products which contain dissolved hydrogen sulphide, asphaltenes and/or resins, under temperature and pressure conditions close to those at which they leave the reaction zone, and the obtained mixture is injected into the reaction zone. Preferably, the catalytic precursor is injected into the part of the conversion effluents that is recycled to the reactor inlet. The invention also relates to a device that can be used for implementing this process.

### FIELD OF THE INVENTION

The present invention relates to a process for hydroconversion of a heavy oil feedstock in which the latter undergoes cracking and/or purification reactions in the presence of hydrogen and a device that can be used to implement this process. The invention therefore applies particularly to hydrocracking and hydrotreatment processes such as the processes of hydrodesulphurization, hydrodenitrogenation, hydrodemetallization or hydrodearomatization of various oil cuts.

The feedstocks treated with this type of process are heavy feedstocks such as distillates or residues from the vacuum distillation of oil. The treated feedstocks can also be coals or cokes introduced in suspension in liquid oil cuts. More generally, the process is particularly suitable for treating oil cuts such as the atmospheric residues obtained by atmospheric distillation at the bottom of the column or a fraction of these residues, or the residues from vacuum distillation (bottom of column). These cuts are generally characterized by a boiling point above 340° C., for at least 90% by weight of the cut. The process is used in particular for heavy feedstocks having a boiling point above 540° C., for at least 80% by weight of the feedstock. They (fresh feedstocks) have a viscosity below 40,000 cSt at 100° C., and preferably below 20,000 cSt at 100° C. They generally have to be converted to produce finished products such as gasoil, gasoline and LPGs with a lower boiling point. These cuts are generally also purified as they contain quantities of sulphur, metals (in particular nickel and vanadium), nitrogen, Conradson carbon and asphaltenes which must fall to allow the lighter cuts produced by conversion to be treated in downstream purification processes or to satisfy the specifications of the final products.

More precisely, said invention makes it possible to inject a dispersed phase containing a catalytic precursor promoting hydroconversion and to carry out its activation by means of a rapid contact under conditions suitable for its activation without degrading it thermally to form an active catalytic phase in the reactor and then to carry out the hydroconversion of the heavy products in one or more reaction zones in the presence of hydrogen.

Depending on the applications, the injection of the catalytic precursor may or may not be carried out in the presence of a catalyst present in the reaction zone. Preferably, the reaction zone of the process therefore operates in a bubbling bed (presence of a catalyst as defined hereafter) or in slurry (in the presence of a circulating catalytic phase).

More particularly but not limitatively, the present invention is used for example in the conversion of a heavy hydrocarbon feedstock introduced in essentially liquid form into a reaction zone, said conversion taking place by establishing contact with a gaseous phase, comprising hydrogen (hydroconversion) and with a catalytic phase and/or a catalyst, under conditions promoting hydroconversion, i.e. at a total pressure that can range from 10 to 500 bar, preferably from 20 to 300 bar, with a partial hydrogen pressure varying from 10 to 500 bar, preferably from 20 to 300 bar, at a temperature of 300 to 600° C., and preferably 350 to 500° C., the contact taking place for a specific time necessary for the conversion of the residue, ranging from 5 m to 20 h and preferably comprised between 1 and 10 h. Depending on the applications, it is possible to envisage the recycling with the feedstock of part of the heavy fractions of the effluents having a boiling point more or less equal to or higher than that of the feedstock by means of a distillation fractionation for example of the effluent downstream of the reaction zone or of the process (downstream of the last reaction zone).

Hereafter, the term “catalytic phase” refers to the solid resulting from the conversion of a catalytic precursor injected into the process and able to be entrained by the liquid, the term catalyst itself referring to a solid present in the reaction zone having catalytic properties, and the size and density properties of which are such that it is not entrained by the liquid outside the reactor. Therefore:

the catalytic phase will therefore travel into the reaction zone(s) of the process according to the invention and leave (at least in part) the reactor, of the process with the liquid effluents.

the catalyst will remain in the reactor.

### STATE OF THE ART

The bubbling-bed process used for the hydroconversion of heavy hydrocarbon or coal fractions is a well-known process which generally consists of bringing into contact, in rising co-current, a hydrocarbon feedstock in liquid phase and a gaseous phase in a reactor containing a hydroconversion catalyst. The reaction zone preferably comprises at least one reactor equipped with at least one means for removing the catalyst situated close to the bottom of the reactor and at least one means for adding the catalyst close to the top of said reactor. This makes it possible to continuously add and remove catalyst and to maintain the activity of the latter if deactivation phenomena are observed. Said reaction zone most often comprises at least one circuit allowing the recycling of the liquid phase, situated inside or outside the reaction zone, said recycling being intended, according to a technique known to a person skilled in the art, to maintain an expansion level of the bed sufficient to ensure the satisfactory operation of the reaction zone in a three-phase operation (gas/solid/liquid). The catalyst is maintained in the fluidized state by means of this recycling.

Another document from the prior art for example describes such a process. A mixture of liquid hydrocarbons and hydrogen is injected through a catalyst bed in such a manner that the bed is expanded. The catalyst level is controlled by recycling the liquid, said catalyst level remaining below that of the liquid. The gas and the hydrogenated liquid cross an interface defining a zone containing the greater part of the solid particles of the catalyst bed and are found in a zone practically free of said particles. After a gas/liquid separation of the fluids from the reaction, said fluids are then divided into two fractions: a fraction containing the greater part of the liquid is recycled to the bubbling pump and another part is removed from the reactor with the gas.

The bubbling-bed process utilizes a supported catalyst, containing metals the catalytic action of which takes place in the form of sulphide, the size of which is such that the catalyst remains wholly in the reactor. The liquid speed in the reactor makes it possible to fluidize or catalyze, but does not make it possible to entrain the latter outside the reaction zone with the liquid effluents. The continuous addition or removal of catalyst is possible and makes it possible to compensate for the deactivation of the catalyst.

U.S. Patent 2003/0021738 shows a new implementation in a bubbling bed, in addition making it possible to separate gas effluents from liquid effluents in the reactor. This novel implementation is useful because it makes it possible to evacuate the liquid effluents separately from the gaseous effluents, whilst still providing a recycling of liquid in the reactor, this separation taking place under the reactor's temperature and pressure conditions. It constitutes an evolutionary change in the slurry and bubbling-bed technologies suitable for hydroconversion of the residues making it possible to limit the number of items of high-pressure equipment in the reaction zone while maintaining easy control of major operating parameters (liquid level and catalyst level in the reactor).

U.S. Pat. No. 3,231,488 shows that it is also possible to achieve a hydrorefining of heavy feedstocks in the presence of a soluble catalyst. In this patent, the inventors claim that metals injected in an organometallic form (the complex forming a catalytic precursor) can form in the presence of other substances (such as the asphaltenes of the colloids), in the presence of hydrogen and/or of H2S, a finely dispersed catalytic phase allowing the hydrorefining of the residue after injection into the feedstock. This catalytic agent then crosses the reaction zone without being separated from the liquid in the reactor. Although this is not known with precision, the size of the particles of the catalytic phase that have formed in this type of process remains small enough for it to be difficult to fluidize these particles in the reaction zone without entraining them with the liquid. The term “slurry implementation” is then used, unlike the preceding process implemented using a bubbling bed. Examples of reactors functioning according to the principles specific to suspension beds (slurry) and bubbling beds as well as their main applications are for example described in “Chemical Reactors, P. Trambouze, H. Van Iandeghem and J. P. Wauquier, ed. Technip (1988).

In U.S. Pat. No. 4,244,839, C. L. Aldridge and R. Bearden claim a catalytic phase, in particular for the hydroconversion of the residues, prepared from a catalytic precursor containing a thermally decomposable metal compound which is brought into contact with a feedstock containing Conradson carbon then brought into contact at a high temperature in the presence of hydrogen and H₂S. Numerous catalytic precursors can serve as thermally decomposable metal compound; in this patent molybdenum, chromium, vanadium, cobalt, nickel naphthenates, tungsten or titanium resinate, phosphomolybdic acid etc. are mentioned. The list is not exhaustive.

Generally, the action of these metal compounds is now fairly well known: under certain conditions, preferentially in the presence of hydrogen sulphide and under certain temperature conditions, these salts, acids or compounds containing metals of Groups II, III, IV, V, VIB, VIIB or VIII decompose and sulphurize to form the metal sulphides the catalytic activity of which in hydroconversion processes promotes the cracking, hydrogenation, hydrodesulphurization, hydrodenitrogenation, hydrodemetallization (etc.) reactions of heavy hydrocarbons. The complexing of the metal atom or atoms with complex organic structures such as resins or asphaltenes present in heavy feedstocks seems to be established, and makes it possible to form a catalytic phase of very small particles containing an active phase based on metal sulphide and coke. Thus, for this type of slurry process, a catalytic precursor was injected into a zone upstream of the reactor in a heavy hydrocarbon feedstock, then this precursor was activated to obtain a finely dispersed catalytic phase which is then injected into the reactor and which will flow with the liquid products.

This slurry technique could prove advantageous compared with the bubbling-bed technique under certain conditions. In fact, the fine dispersion of the catalytic phase in slurry mode can make it possible to promote the hydrogenation and conversion of very coarse hydrocarbon structures, such as resins and asphaltenes, the final conversion of which is made difficult on supported catalysts because of the more limited accessibility of the active sites inside the pores. In the case of strongly metallized feedstocks also, a slurry process can prove very advantageous as metals, which are known to promote the deactivation of the catalyst, are continuously removed with the finely dispersed catalyst and no longer accumulate on the supported catalyst (which would then require very considerable additions and removals of catalyst). It is clear that this utilization is particularly useful if deactivation is substantial.

Mention may also be made of the patent EP 0559 399 which proposes the simultaneous utilization of a supported catalyst in the presence of a slurry-type dispersed catalyst, formed by decomposition of a catalytic precursor such as a metal naphthenate. In the presence of an injection of aromatics, this makes it possible to limit the quantity of insoluble substances formed in the products and therefore to improve the stability of the products.

However, for the slurry technique to be effective, the conversion of the catalytic precursor should be wholly controlled. Thus Cyr et al., in U.S. Pat. No. 5,578,197 mention that the catalytic precursor, if heated for a certain time under unsuitable conditions, can lead to a substantial formation of coke during the hydroconversion reactions (they mention the formation of coarse particles the size of which can be as much as 4 mm; these particles behave in the reactor like a catalyst and not a catalytic phase and it is therefore very difficult for them to be entrained with the liquid, which leads to risks of agglomerations and blockages inside the reactor). Cyr et al. propose a controlled mixing under mild conditions to promote dispersion before heating of the precursor and the introduction of the precursor or the catalytic phase into the reactor.

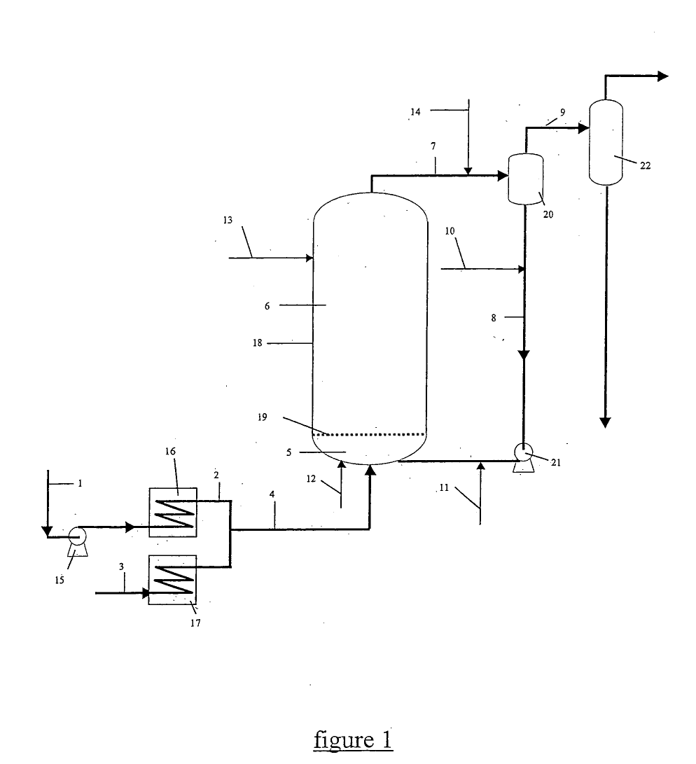

Numerous techniques of the molybdenum precursor are presented in the literature. Thus the U.S. Pat. No. 4,244,839 proposes the mixing of the catalytic precursor with the feedstock upstream of the reactor and direct injection into same (FIG. 1 of the cited patent) in the presence of hydrogen and H2S. There is no mention of preheating the feedstock upstream of the reactor. However, for a process of hydroconversion of residues to operate in favourable conditions, it is essential to preheat the feedstock and to increase its pressure in accordance with the conditions required to carry out the reaction, before introducing it into the reactor. It is thus probable that such an arrangement leads to a thermal degradation of the molybdenum precursor before it is introduced into the reactor and harms its subsequent catalytic activity.

In the U.S. Pat. No. 3,674,682, a hydroconversion process in slurry form is claimed. Here too, the dispersed catalyst is injected upstream of the reactor with the feedstock and hydrogen, which will probably result in its thermal degradation as mentioned in the preceding paragraph.

In the U.S. Pat. No. 6,043,182, a method of preparing a catalytic precursor upstream of a reactor is claimed. The catalytic precursor in aqueous form is mixed with a hydrocarbon to form an emulsion, then is heated to eliminate water before the reactor. Here too, there is the risk of a thermal degradation of the organometallic complex formed with the heavy compounds once the aqueous phase has evaporated before introduction into the reactor.

In the U.S. Pat. No. 5,108,581, a process for hydroconversion of residues is proposed including a zone for preparation of the catalytic precursor: mixing with a heavy hydrocarbon then sulphurization in a chamber at at least 500° F., for a specific time necessary to convert the molybdenum precursor into sulphide before introducing it into the hydroconversion reactor. Such an arrangement is complex because it requires contact with a sulphurizer in a specific chamber. To avoid the thermal degradation of the feedstock, it is necessary to keep the temperature probably below 350° C., which definitely requires a fairly long sulphurization time and thus necessitates a chamber large enough for the mixture to reside in for the time required.

Thus, in all the processes of the prior art, in the absence of strict control of temperature conditions (i.e. operating below 350° C.), there is a partial thermal degradation of the catalytic precursor. This results in a limited activation of the precursor in catalytic phase and the formation of often sticky particles of substantial size that are difficult to evacuate from the reaction zone and which could settle, coke and block the reactor.

Nevertheless, the activation of the catalyst requires the contact, in the presence of heavy molecules, of the catalytic precursor with a sulphurizer such as hydrogen sulphide (H2S). This contact generates the sulphurization of the metal or metals contained in the catalytic precursor and the higher the temperature the quicker this reaction. If the temperature is not high enough, thermal degradation reactions of the precursor, making its sulphurization more difficult, can be observed as the reaction proceeds.

To overcome these disadvantages, the prior art proposes to control the conditions of mixing and exposure to temperature. However, this, lengthens the preparation time of the catalyst and requires additional expenditure.

Another process has been sought which allows sufficient activation but without degrading the catalytic precursor. Surprisingly, and unlike previous techniques, the process of the invention provides a solution that is extremely easy to implement, and for carrying it out in a bubbling bed, it uses arrangements that already exist in industrial units, thus reducing installation costs. The invention also overcomes the disadvantages of the processes of the prior art.

### SUMMARY OF THE INVENTION

The invention relates to a process for hydroconversion in a reaction zone of liquid heavy hydrocarbon feedstocks containing sulphur, in the presence of hydrogen and a catalytic solid phase, said solid phase being obtained from a catalytic precursor, a process in which the catalytic precursor is injected into a part of the liquid conversion products which contain dissolved hydrogen sulphide, asphaltenes and/or resins, under temperature and pressure conditions close to those at which they leave the reaction zone, and the obtained mixture is injected into the reaction zone.

The invention thus consists of injecting the catalytic precursor into a part of the liquid reaction products containing dissolved hydrogen sulphide under conditions as close as possible to the temperature and pressure conditions at the outlet of the reactor. In hydroconversion processes, the reaction is in fact generally exothermic and the highest temperature is usually encountered at the outlet of the reactor. The liquid products of the reaction contain a large proportion of dissolved hydrogen sulphide from the hydrodesulphurization of the feedstock molecules which takes place outside the hydroconversion reactions. Finally, the liquid products of the reaction also contain non-negligible quantities of unconverted feedstock fractions such as asphaltenes which with the metal sulphide will form the sought catalytic phase.

At the moment of injection of the precursor into the process, it is important to maintain conditions close to those encountered on leaving the reactor. The temperature must remain the highest possible close to the reactor temperature to promote the sulphurization of the catalytic precursor. If, on the other hand, the temperature is certainly higher than in the reactor, a decrease in the concentration of sulphur in the liquid, resulting from the desorption of sulphur-containing molecules such as dissolved H2S, will be observed, also limiting the sulphurization of the catalytic precursor. The pressure must also remain close to the pressure on leaving the reactor; too large a decrease in pressure would have a similar effect to an increase in temperature; but an increase in pressure would on the other hand not have an adverse effect on the conditioning of the precursor.

It will thus be ensured that the temperature Tmel, mixing temperature, resulting from the contact of the precursor with the liquid conversion products, is preferably comprised in the range Ts±50° C., (Ts=temperature at which they leave the reaction zone), preferably ±10° C., and that the total contact pressure Pmel is preferably at least equal to Ps −20 bar (Ps=total pressure Ps on leaving the reaction zone), preferably −1-bar or −5 bar, and preferably comprised in the range Ps±20 bar or Ps±10 bar, preferably Ps±5 bar. In general, the temperature Tmel is above 350° C., and preferably comprised between 380 and 500° C.

Preferably, the catalytic precursor is injected into said liquid products the temperature Tmel of which is comprised in the range Ts±50° C., (Ts=temperature at the outlet of the reaction zone of said liquid products), preferably ±10° C., and the total pressure Pmel is at least equal to Ps−20 bar (Ps=pressure at the outlet of the reaction zone of said liquid products), preferably −10 bar or −5 bar, and preferably comprised in the range Ps±20 bar or Ps±10 bar, preferably Ps±5 bar.

In general, the temperature Tmel is above 350° C., and preferably comprised between 380 and 500° C.

These favourable conditions are found in the recycling line(s) of the reaction effluents (before total separation of the hydrogen sulphide), whether it (they) is (are) outside or inside the reactor.

Advantageously, the invention thus relates more precisely to the injection of a catalytic precursor in the presence of products of the hydroconversion reaction, for example in a line recycling the liquid inside the reaction zone where hydrogen sulphide is present, a high temperature promoting the rapid sulphurization of the precursor and the asphaltenes. The pressure and temperature conditions encountered in these conditions actually remain very close to the conditions at the outlet of the reactor, subject to the loss of feedstock and the variation in hydrostatic pressure in the recycling line, subject to any thermal losses.

More particularly, the present invention relates to a process for hydroconversion of heavy feedstock using a catalytic precursor injected, preferably regularly, into one or more reactors that may be provided with means for internal recycling of the liquid fractions, in conditions which allow its optimum activation without degradation.

These internal liquid recycling lines are known to a person skilled in the art and already widely used in bubbling-bed reactors to recycle a part of the liquid and increase the surface speed of the liquid in the reactor and promote the bubbling of the supported catalyst in processes using this type of catalyst, such as H-Oil type residue hydroconversion processes. Their use as initial contact zone of a catalytic precursor is an innovation proposed within the scope of this invention.

In one embodiment, the conversion products from the reaction zone are separated in an internal liquid/gas separator, and the catalytic precursor is injected into the liquid part recycled to the reaction zone.

In another embodiment, the conversion products from the reaction zone are separated in an external liquid/gas separator, and the catalytic precursor is injected into the liquid part recycled to the reaction zone.

In another embodiment, the catalytic precursor is injected before the external liquid/gas separation and is recycled to the reaction zone with the recycled conversion products.

The catalytic precursor may also be injected into the reaction zone directly or via a mixing zone operating under conditions close to those at the outlet of the reactor, in a place where the precursor will meet the conversion products with dissolved hydrogen sulphide (for example in the distribution chamber of the reactor). However, these embodiments have the disadvantage of less control of the dispersion and/or the mixture in the liquid of the catalytic precursor, taking into account the possible presence of supported catalyst and gas bubbles, which leads to lower performance levels than those obtained with the other cited injection methods.

All these embodiments are used alone or in combination.

The catalytic precursors that can be considered within the scope of the invention are typically organometallic compounds, salts or acids, linked to one or more metals of groups II, III, IV, V, VIB, VIIB or VIII, such as molybdenum-based compounds such as molybdenum naphthenate, molybdenum octoate, ammnobium heptamolybdate or phosphomolybdic acid.

The conditions promoting hydroconversion are in general the following:
Total pressure comprised between 10 and 500 bar, preferably 20-300 bar
Partial hydrogen pressure comprised between 10 and 500 bar, preferably 20-300 bar
Temperature comprised between 300 and 600° C., preferably between 350 and 500° C.,
Residence time of the liquid hydrocarbons in the reaction zone between 5 m and 20 h, preferably between 1 h and 10 h.

To promote the dispersion of the catalytic precursor in the reaction effluents it can be useful to introduce the precursor mixed with a hydrocarbon feedstock pumpable under the injection conditions and containing polyaromatic molecules promoting the dispersion of the metal or metals such as resins or asphaltenes. This liquid hydrocarbon will thus preferably contain fractions of the atmospheric residue such as vacuum distillates or vacuum residues.

According to a preferred method of the invention, the temperature in the injection line (before establishing contact between catalytic precursor and the liquid conversion products) will be below 200° so as to avoid any thermal degradation of the precursor before its conversion into catalytic phase. The catalytic precursor will then be placed in contact with at least part of the reaction effluents under conditions close to the conditions at the outlet of the reactor considered for injection, as described above.

The precursor is preferably injected regularly and preferably continuously. It can also be injected intermittently as required by the process.

Several reaction zones can be linked to one or more reactors in series or several parallel trains of reactors in series, the reactors being able to comprise the correct recycling means for the liquid, and separation means downstream of the reactors.

In the case of a set of several reactors in series, the catalytic precursor will preferably be injected upon contact with the reaction effluents of the first reactor.

Said first reactor will preferably comprise internal means for recycling the liquid. The other reactors can also comprise said means. At least one external separation means is advantageously arranged between 2 successive reactors to at least partially degas the effluent.

Moreover, means of separation by distillation will if necessary allow the heavy fractions (boiling point generally equal to or above that of the feedstock) to be separated from the reaction effluents from the reaction zone (or zones) (and preferably from the last zone when the process comprises several of same). At least part is recycled as well as part of the catalytic phase (contained in the said fractions) upstream of the process, at the inlet of one of the reactors (generally the first reactor) mixed with its liquid feedstock. The conversion of the residual fractions is promoted and the quantity of the catalytic phase in the reaction zone is increased.

A zone for preheating the feedstock and hydrogen-containing gas is usually provided. To limit the flocculation (under certain conditions) of the unconverted heavy compounds such as asphaltenes, an aromatic cut (which is strongly aromatic, such as for example a catalytic cracking HCO cut) can be injected into the process, for example with the feedstock upstream of one of the zones (reactors) of the process or with the effluent before distillation and for example with the fresh feedstock, or at the external separator, if there is one, or the distillation unit.

These methods can be combined.

The conversion products will, at the end of the hydroconversion, usually be separated, preferably by distillation.

The invention also relates to a device containing at least one reactor with a reaction zone (6) containing a catalytic phase formed from a catalytic precursor, at least one line (4) for the introduction of a heavy liquid feedstock containing sulphur, asphaltenes and/or resins, and a line conducting hydrogen (3), at least one line for the evacuation of the liquid conversion products and at least one line for the injection of the catalytic precursor into at least part of the liquid conversion products, saturated in H2S and containing asphaltenes and/or resins.

This device preferably comprises, linked to the line for the evacuation of the liquid conversion products, a recycling line (8) to the reaction zone for at least part of the liquid conversion products, saturated in H2S and containing asphaltenes and/or resins, and a line for the injection of the catalytic precursor into said recycling line (8). Advantageously, the recycled liquid has been at least partially degassed by passage into a liquid/gas separator outside or inside the reactor, for the separation of a liquid-gas or liquid fraction.

In an advantageous embodiment, the device is provided with a line outside the reactor for the evacuation of the effluents (including the liquid conversion products) outside the reactor, a line (14) for the injection of the catalytic precursor into the line (7), a means for liquid/gas separation (20) outside the reactor for the separation of part of the liquid conversion products containing dissolved hydrogen sulphide, asphaltenes and/or resins, said part being at least partially recycled to the reaction zone via a line (8).

In another version, the device is provided with a line outside the reactor for the evacuation of the effluents (including the liquid conversion products) outside the reactor, a means for liquid/gas separation (20) outside the reactor for the separation of part of the liquid conversion products containing dissolved hydrogen sulphide, asphaltenes and/or resins, said part being at least partially recycled to the reaction zone via a line (8) and the device being provided with a line (10 or 11) for the injection of the catalytic precursor into the recycling line (8).

In another version the device is provided with a line (12) for the injection of the catalytic precursor into the distribution chamber of the reactor which contains dissolved H2S as a result of the mixing of the feedstock with part of the recycled effluent.

In another version, the device is provided with a line (13) for the injection of the catalytic precursor direct into the reaction zone.

In another version, the device is provided with an internal liquid/gas separator (20) for the separation of part of the liquid conversion products containing dissolved hydrogen sulphide, asphaltenes and/or resins, said part being evacuated and at least partially recycled to the reaction zone via a line (8), and the device being provided with a line (10 or 11) for the injection of the catalytic precursor into the recycling line (8).

The described versions are used alone or in combination.

The device can comprise at least 2 successive reactors, each with a reaction zone (6) containing a catalytic phase formed from a catalytic precursor, with a first reactor as described-above, provided with a line for recycling the effluent from the first reactor to said first reactor, the non-recycled separated liquid being sent into the following reaction zone or evacuated.

In a preferred embodiment, the device comprises at least 2 successive reactors, each with a reaction zone (6) containing a catalytic phase formed from a catalytic precursor, with a first reactor as described above, said device comprising for each reactor a line for recycling the liquid after at least partial degassing in a liquid/gas separator, the non-recycled separated liquid being sent into the following reaction zone or evacuated.

In addition, the device (in general) advantageously comprises at least one distillation column situated after the last reaction zone, for the separation of the heavy fractions from the reaction effluents that contain part of the catalytic phase, and a line for recycling at least part of said upstream fractions with its liquid feedstock.

Advantageously, the device is fitted with at least one line for the introduction of an aromatic cut into the feedstock upstream of at least one reactor and/or into the effluent before distillation.

FIGS. 1 to 4 illustrate the invention:

FIG. 1 represents a reactor with a recycling line from an external separator and embodiments of the injection of the catalytic precursor,

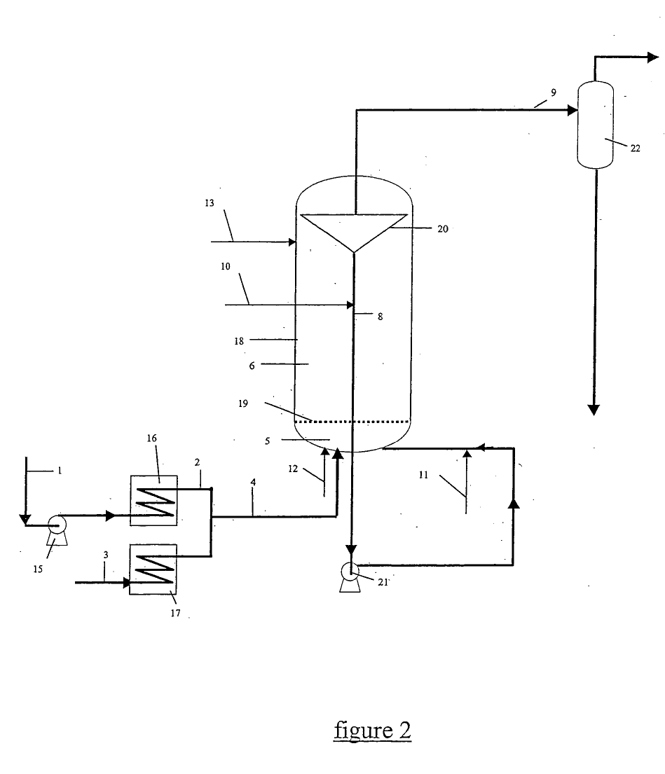

FIG. 2 shows a recycling line from an internal separator and also embodiments of the injection of the catalytic precursor,

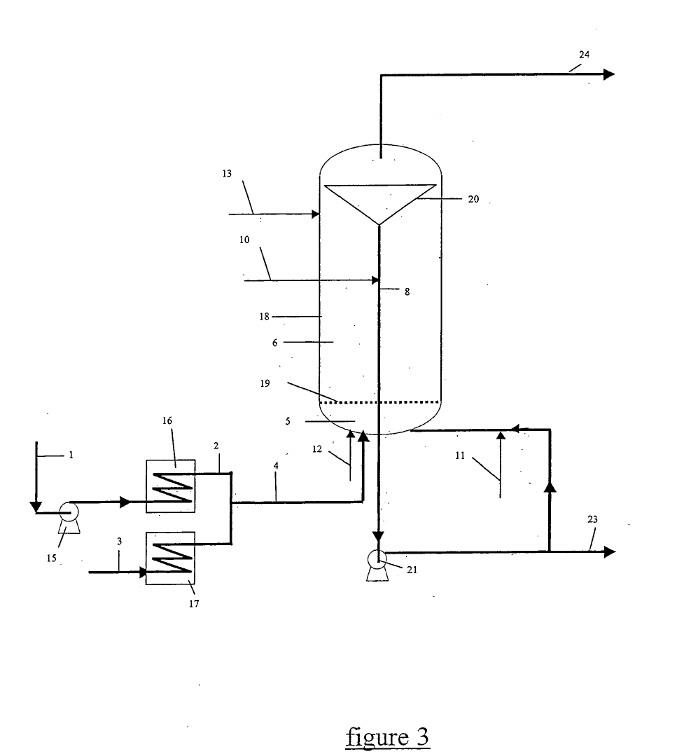

FIG. 3 includes the 2 types of recycling line from an internal gas/liquid separator,

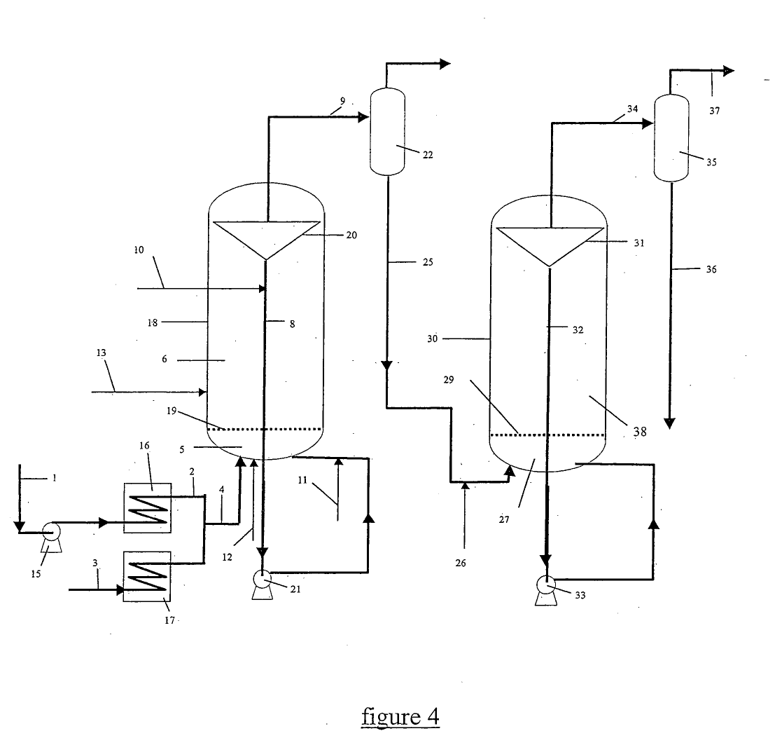

FIG. 4 represents a zone with 2 reactors, each having a recycling line from the internal separator.

According to a first embodiment of the invention (FIG. 1) the hydroconversion of the residues is carried out in a reaction zone constituted by a single reactor. The feedstock of heavy hydrocarbons, advantageously constituted essentially by compounds from the atmospheric distillation or the vacuum distillation of an oil fraction, flows in a line (1) at a temperature which allows it to flow, generally varying between 50° and 180° according to the nature of the feedstock and its bubbling properties.

The feedstock is then pressurized (in general between 10 and 500 bar, often about 100-300 bar), for example by means of pumps (15), then preheated without thermal cracking, for example in an oven (16). For residue-type oil feedstocks, the temperature on leaving the ovens is intentionally limited to 300-380°, preferably 350° C., to avoid any cracking and any thermal degradation linked to the temperature. The pressurized and thus preheated feedstock (2) is then mixed with a gas (3) containing hydrogen and preferably a very large proportion of hydrogen, preheated preferably in a separate oven (17) at a temperature that can range from 100 to 800°, and is preferably comprised between 300 and 600°.

The mixing of the feedstock with the hydrogen-containing gas allows the temperature of the feedstock+gas mixture (4) to be adjusted to a temperature close to that of the reaction (typically 380-500° C.) without thermally degrading the feedstock. The whole is then introduced into the reactor (18) in a mixing zone (5) situated upstream of distribution means (19) (in FIG. 1 distribution chamber of the reactor) allowing the uniform distribution of the gas and of the liquid over the section of the reaction zone. Other methods of conditioning the feedstock are equally possible: the feedstock (1) and the gas (3) containing the hydrogen can for example be mixed before the feedstock-preheating oven (16). Also, the pressurized and preheated liquid can be introduced on the one hand, and the pressurized and preheated gas separately, on the other hand, into the reaction zone. It must then simply be ensured that the pressure of the feedstock and temperature of each of the flows are increased to satisfy the temperature and pressure conditions required to carry out the reaction.

The gas (3) mixed with the feedstock and containing hydrogen generally comes partly from the recycling of the non-condensed gaseous fractions downstream of the reaction zone, optionally purified to eliminate the H2S formed during the reaction and to which extra hydrogen will have been added to compensate for the consumption of part of this gas in the reaction zone.

The method of introducing the feedstock and the hydrogen that is described in the present case is purely illustrative and does not limit the invention. All these types of conditioning of the feedstock are well known to a person skilled in the art.

The reaction takes place in a (reaction) zone of the reactor (6) situated above distribution means (19) in which optionally a supported catalyst is located in the form of beads or extrudates of an equivalent diameter generally comprised between 0.25 and 10 mm and having a dry-grain density generally comprised between 1000 and 5000 kg/m3. The reaction zone is preferably an appreciably elongated zone in which the surface speed of the liquid is sufficient to keep the supported catalysts bubbling (VSL>VMF) and to avoid the decantation and settling of all the particles formed starting from the catalytic precursor in the reactor and to avoid the entrainment of the particles of supported catalyst (VSL<UT).

On leaving the reactor, the gas and liquid effluents (7) (including the catalytic phase constituted by the particles formed starting from the catalytic precursor) are evacuated to a degasser (20) outside the reaction chamber. The supported catalyst remains in the reaction chamber as the surface speed of the liquid is not sufficient to cause its entrainment. The function of the degasser (20) is to remove most of the gas (at least the coarse bubbles) from part of the liquid. The at least partially degassed liquid (8) is recycled to the inlet of the reactor (18) via a pump (21) allowing the necessary pressure to be reapplied to it. The gas and the non-degassed liquid are evacuated via the line (9). The degassed liquid (8) and the non-degassed liquid (7) still contain a large proportion of dissolved H2S, as the temperature and the pressure are more or less that of the reactor (18), subject to thermal losses and to pressure drops of the equipment. It is thus possible to add the catalytic precursor downstream of the reactor (18). Due to the internal recycling, this will then be reintroduced into the reactor (18). The precursor will immediately be subjected to an increased temperature in the presence of H2S, which will allow the sulphurization of the precursor and the formation of fine particles upon contact with asphaltenes that are unconverted after passage in the reactor.

The catalytic precursor is injected by a pump directly upon contact with the products of the reaction or diluted with a hydrocarbon feedstock preferably containing resins or asphaltenes, the viscosity of which at a temperature below 190° C., (to prevent any thermal degradation of the catalytic precursor) allows transportation and pumping.

Several possible points for the injection of the catalytic precursor have been shown in FIG. 1 and the other figures. These methods are not limited to the precise embodiments of the figures and can be used alone or in combination.

The catalytic precursor can be injected into a liquid saturated with H2S and at least partially degassed (travelling in the recycling line (8)) upstream (reference 10) or downstream (reference 11) of the bubbling pump (21) or into the distribution chamber (5) of the reactor (reference 12) or directly into the reaction zone (reference 13) or upstream of the degasser (reference 14).

In each of these cases, the catalytic precursor will encounter high-temperature H2S and unconverted asphaltenes. The injections (10) and (11), due to the absence of gas bubbles, do however allow the mixture to be better controlled and thus represent a preferred implementation of the invention. Moreover, the contact temperature between the precursor and the effluents is higher there than in (12) for example, as the effluent is not diluted with the fresh feedstock. This will result in a more efficient activation.

It will be noted that FIG. 1 presents a preferred version with recycling of part of the effluent from the reaction, but it is also possible not to recycle, the injection points then being (12) or (13).

On leaving the degasser, a gas-liquid separation takes place under pressure in the flask (22). The liquid, leaving at the bottom of the separator (22), is generally sent after expansion to a fractionation unit allowing the converted oil cuts and the residual fractions to be recovered. The gas, leaving the separator (22) overhead, then passes into a line of separators from which the noncondensable products including hydrogen can be extracted which are often recompressed and recycled into the process upstream of the reaction zone after treatment.

FIG. 2 represents another embodiment of the invention, different from the first in that the degassing on leaving the reactor is carried out inside the reactor (18), the other arrangements described above applying to this embodiment.

The mixture of liquid hydrocarbons and hydrogen is injected via a distributor (19) into the reactor (18). The description of the conditioning of the feedstock, identical to the preceding figure, will be not be repeated here.

If catalyst is present in the reactor, the flow rate of liquid in the reactor, resulting from the flow rate of fresh feedstock (4) and the internal recycling (8), is controlled in such a manner that the catalyst bed is expanded. The level of catalyst is controlled by means of the recycling (8) of the liquid.

On leaving the reaction zone (6), after a gas/liquid separation in an internal separator (20) of the fluids from the reaction, said fluids are then divided into two fractions: a fraction containing the greater part of the liquid is recycled via the line (8) to the bubbling pump (21) and another part is drawn off from the reactor with the gas (9). The recycled liquid is reintroduced into the reaction zone preferably via a separate line (FIG. 2), but could also be introduced into the line conducting the feedstock (for example (4) in FIG. 2).

The possible points for injection of the catalytic precursor, as described in FIG. 1, can be seen. The catalytic precursor can be injected into a liquid that is saturated in H2S and at least partially degassed (travelling in the evacuation line (7) or recycling line (8)) upstream (the two references 10 and 10′) or downstream (reference 11) of the bubbling pump (21) or into the distribution chamber (5) of the reactor (reference 12), or directly into the reaction zone (reference 13).

The conditions Ps and Ts are those prevailing in the internal separator (20).

A gas/liquid separation is advantageously carried out in the flask (22) on the liquid/gas portion drawn off via the line (9), the arrangements relating to this part which are described in FIG. 1 being suitable.

For FIGS. 3 and 4, the description of the conditioning of the feedstock, identical to that of the preceding figures, will not be repeated here.

FIG. 3 represents a third embodiment of the invention, different from the second in that the separator (20) situated in the reactor (18) is now a set of means allowing the liquid to be separated from the gas and not the liquid from a gas-liquid mixture. The result is that the effluent (24) of the reactor is now an essentially gaseous phase (possibly containing non-separated traces of liquid). The non-recycled part of the liquid products is now evacuated via a line (23) situated upstream or downstream (preferred) of the liquid pumping means (21), but upstream of the distribution chamber (19).

At the outlet of the reactor of the reaction zone (6), after a gas/liquid separation in an internal separator (20) of the fluids from the reaction, said fluids are then divided into two fractions: a fraction containing the greater part of the liquid is recycled via the line (8) to the bubbling pump (8) (21) and another, gaseous part is drawn off from the reactor via the line (24).

The recycled liquid is reintroduced into the reaction zone preferably by a separate line (FIG. 3); it could also be introduced into the line conducting the feedstock (for example (4) in FIG. 3).

The possible points for injection of the catalytic precursor, as described with regard to FIG. 1 can be seen. The catalytic precursor can be injected into a liquid that is saturated in H2S and at least partially degassed (travelling in the line (7) or recycling (8)) upstream (reference 10) or downstream (reference 11) of the bubbling pump (21) or into the distribution chamber (5) of the reactor (reference 12) or directly into the reaction zone (reference 13).

The conditions Ps and Ts are those prevailing in the internal separator (20).

It will be noted that the separation of the gas from the liquid is carried out in the separator (20) such that the flask (22) described in FIGS. 1 and 2 is not always expedient.

FIG. 4 represents an embodiment of the invention in which several reactors are connected in series.

The arrangements numbered (1) to (23) of FIG. 2 for the first reactor provided with an internal separator can be seen.

In the specific case of FIG. 4, the second reactor is fed (line 26) by the non-vaporized fractions from the first reactor containing most of the unconverted fractions, separated by an external separator of the type (22) of that of FIG. (2).

In another arrangement (not shown), the second reactor can be fed by the liquid part not recycled from the first reactor provided with an internal separator of the type (20) of FIG. 3, this part preferably having been at least partially degassed.

The hydrogen, preheated or not, is then generally introduced into the liquid feedstock of the second reactor (line 26). It is also possible to cool the liquid effluent from the first reactor before its introduction into the second reactor.

The addition of a second reactor (28) allows conversion to be improved for an identical reactor volume. In fact, the succession of two small-volume mixed conversion zones allows a better conversion than a single mixed zone of equivalent volume. Such an arrangement also allows a temperature gradient to be imposed between the two reactors, which will allow the stability of the formed products to be better controlled, in particular when the conversion of the residue is very high. The operation of the second reactor is generally more or less similar to the operation of the first reactor.

A distributor (29) allows the satisfactory distribution of the gas and the liquid. The reaction takes place in the reaction zone (30) situated in the reactor above the distributor (19) in the presence or not of a catalyst.

The effluents are separated in an internal separator (31) as in the version in FIG. 2, allowing part of the liquid effluents from the reaction to be recycled (evacuation-recycling line 32) and the non-recycled gas-liquid effluents to be evacuated (line 34). Downstream of the reactor, a separator (35) carries out a separation of the gas, evacuated overhead (line 37) and of the liquid evacuated at the bottom (line 36).

The conversion products are recycled via a pump (33) to the reaction zone.

In the case of multiple reaction zones as represented in FIG. 4, the catalytic precursor will be injected by a pump directly upon contact with the products of the reaction of the first reactor, alone or diluted with a hydrocarbon feedstock preferably containing resins or asphaltenes, the viscosity of which at a temperature below 200° C., allows transportation and pumping. To prevent any thermal degradation of the catalytic precursor, its temperature is preferably kept below 190° C.

The possible points for the injection of the catalytic precursor, as described with regard to FIG. 2, can be seen. The catalytic precursor can be injected into a liquid that is saturated in H2S and at least partially degassed (travelling in the recycling line (8)) upstream (reference 10) or downstream (reference 11) of the bubbling pump (21) or into the distribution chamber (5) of the reactor (reference 12), or directly into the reaction zone (reference 13).

In each of these cases, the catalytic precursor will encounter high-temperature H2S and unconverted asphaltenes. The injections (10) and (13), due to the absence of gas bubbles, do however allow the mixture to be better controlled and thus represent a preferred implementation of the invention.

It is also possible to inject a quantity of catalytic precursor in a similar manner into the second reactor. The injection can take place in the second reactor, alone or combined with an injection in the first reactor. Consequently, the possible injection points are the same as previously.

However, as the dispersed catalyst travels in the process following the liquid, all of the dispersed catalyst injected into the first reactor will pass into the second reactor. It is thus not generally necessary, although it is possible, to inject dispersed catalyst into the downstream reactors.

A series of several successive reactors numbering more than 2 can also be envisaged.

1. A process comprising hydroconversion in a reaction zone of heavy hydrocarbon feedstocks containing sulphur, in the presence of hydrogen and a catalytic solid phase, said solid phase being obtained from a catalytic precursor, wherein the catalytic precursor is injected into a part of the liquid conversion products which contain dissolved hydrogen sulphide and asphaltenes and/or resins, under temperature and pressure conditions close to those at which they leave the reaction zone, and the obtained mixture reacts in the reaction zone.

2. A process according to claim 1 in which the mixing temperature Tmel, resulting from the contact of the precursor with said liquid products, is comprised in the range Ts±50° C., (Ts temperature at which said liquid products leave the reaction zone), and the total pressure Pmel is at least equal to Ps −20 bar (Ps=pressure at which said liquid products leave the reaction zone).

3. A process according to claim 1 in which the catalytic precursor is injected into said liquid products the temperature Tmel of which is comprised in the range Ts±50° C., (Ts=temperature at which said liquid products leave the reaction zone), and the total pressure Pmel is at least equal to Ps −20 bar (Ps=total pressure at which said liquid products leave the reaction zone).

4. A process according to claim 2 in which the temperature Tmel is above 350° C.

5. A process according to claim 3 in which the temperature Tmel is comprised between 380° C., and 500° C.

6. A process according to claim 1 in which the catalytic precursor, before being placed in contact with the liquid conversion products, is at a temperature below 200° C.

7. A process according to claim 1 in which the precursor is mixed with a hydrocarbon feedstock pumpable under the injection conditions and containing asphaltenes and/or resins.

8. A process according to claim 1 in which the catalytic precursor is an organometallic compound, a salt or a molybdenum-based acid.

9. A process according to claim 1 further comprising separating the conversion products from the reaction zone in an internal liquid/gas separator, and injecting the catalytic precursor into the liquid part recycled to the reaction zone.

10. A process according to claim 1 further comprising separating the conversion products from the reaction zone in an external liquid/gas separator, and injecting the catalytic precursor into the liquid part recycled to the reaction zone.

11. A process according to claim 10 in which the catalytic precursor is injected before the external liquid/gas separation and is recycled to the reaction zone with the recycled conversion products.

12. A process according to claim 1 further comprising injecting the catalytic precursor into the distribution chamber of the reactor.

13. A process according to claim 1 further comprising injecting the catalytic precursor into the reaction zone directly.

14. A process according to claim 1 further comprising distillation of the reaction effluents from the reaction zone, or the last reaction zone when the process comprises several reaction zones, and which contain part of the catalytic phase so as to obtain at least one heavy fraction and recycling at least part of said at least one heavy fraction upstream of the process, at the inlet of one of the reactors, mixed with its liquid feedstock.

15. A process according to claim 1 in which a supported catalyst is arranged in the reaction zone and conducting the reaction as a bubbling bed;

16. A process according to claim 1 wherein the process being used in the reaction zone is conducted in the form of a slurry bed.

17. A process according to claim 1 in which the heavy feedstock has a boiling point above 340° C., for at least 90% by weight of the feedstock.

18. A process according to claim 1 in which the heavy feedstock has a boiling point above 540° C., for at least 80% by weight of the feedstock.

19. A process according to claim 1 in which the heavy feedstock has a viscosity below 40,000 cSt at 100° C.

20. A process according to claim 1 in which a heavy aromatic cut is injected into the process.

21. A process according to claim 20 in which the injection is made into the feedstock upstream of one of the zones of the process, and/or into the effluent before distillation, and/or with the fresh feedstock, and/or in a external separator and/or in a distillation unit.

22. A device containing at least one reactor with a reaction zone (6) containing a catalytic phase formed from a catalytic precursor, at least one line (4) for the introduction of a liquid heavy feedstock containing sulphur, asphaltenes and/or resins, and a line conducting hydrogen (3), at least one line for the evacuation of the liquid conversion products and at least one line for the injection of the catalytic precursor into at least part of the liquid conversion products, saturated in H2S and containing asphaltenes and/or resins.

23. A device according to claim 22 comprising, linked to the line for the evacuation of the liquid conversion products, a recycling line (8) to the reaction zone for at least part of the liquid conversion products, saturated in H2S and containing asphaltenes and/or resins, and a line for the injection of the catalytic precursor into said recycling line (8).

24. A device according to claim 22 provided with a line outside the reactor for the evacuation of the effluents outside the reactor, a line (14) for the injection of the catalytic precursor into the line (7), a means for liquid/gas separation (20) outside the reactor for the separation of part of the liquid conversion products containing dissolved hydrogen sulphide, asphaltenes and/or resins, said part being at least partially recycled to the reaction zone via a line (8).

25. A device according to claim 22 provided with a line outside the reactor for the evacuation of the effluents outside the reactor, a means for liquid/gas separation (20) outside the reactor for the separation of part of the liquid conversion products containing dissolved hydrogen sulphide, asphaltenes and/or resins, said part being at least partially recycled to the reaction zone via a line (8) and the device being provided with a line (10 or 11) for the injection of the catalytic precursor into the recycling line (8).

26. A device according to claim 22 provided with a line (12) for the injection of the catalytic precursor into the distribution chamber of the reactor.

27. A device according to claim 22 provided with a line (13) for the injection of the catalytic precursor directly into the reaction zone.

28. A device according to claim 22 provided with an internal liquid/gas separator (20) for the separation of part of the liquid conversion products containing dissolved hydrogen sulphide, asphaltenes and/or resins, said part being evacuated and at least partially recycled to the reaction zone via a line (8), and the device being provided with a line (10 or 11) for the injection of the catalytic precursor into the recycling line (8).

29. A device comprising at least 2 successive reactors, each with a reaction zone (6) containing a catalytic phase formed from a catalytic precursor, with a first reactor according to claim 22, provided with a line for recycling the effluent from the first reactor to said first reactor, the non-recycled separated liquid being sent into the following reaction zone or evacuated.

30. A device comprising at least 2 successive reactors, each with a reaction zone (6) containing a catalytic phase formed from a catalytic precursor, with a first reactor according to claim 22, said device comprising for each reactor a line for recycling liquid after at least partial degassing in a liquid/gas separator, the non-recycled separated liquid being sent into the following reaction zone or evacuated.

31. A device according to claim 22 comprising at least one distallation column situated after the last reaction zone, for the separation of the heavy fractions from the reaction effluents that contain part of the catalytic phase, and a line for recycling at least part of said fractions, upstream of the inlet of one of the reactors, mixed with its liquid feedstock.

32. A device according to claim 22 provided with at least one line for the introduction of an aromatic cut into the feedstock upstream of at least one reactor and/or into the effluent before distillation.
